(19) United States
(12) Patent Application Publication
(10) Pub. No.: US 2024/0341508 A1
(43) Pub. Date: Oct. 17, 2024

(54) BACK RELIEF DEVICE

(71) Applicant: Robert Bagnall, The Woodlands, TX (US)

(72) Inventor: Robert Bagnall, The Woodlands, TX (US)

(21) Appl. No.: 18/135,172

(22) Filed: Apr. 16, 2023

(51) Int. Cl. A47G 9/06; A61H 1/00

(52) U.S. Cl. CPC A47G 9/062; A61H 1/006; A61H 2201/1695; A61H 2205/081

(57) ABSTRACT

A back relief device, including a mat base to receive at least a portion of a body of a user thereon, a plurality of large pressure ridges disposed on at least a portion of the mat base to at least partially protrude away from the mat base with respect to a direction and positioned based on at least one first pressure point of the user, and a plurality of small pressure ridges disposed between each of the plurality of large pressure ridges on at least a portion of the mat base to at least partially protrude away from the mat base with respect to the direction and positioned based on at least one second pressure point of the user.

### BACKGROUND

### 1. Field

The present general inventive concept relates generally to back therapy, and particularly, to a back relief device.

### 2. Description of the Related Art

Many people use chiropractic care for treatment of health problems through manipulation of a back and/or a spine. Using controlled movements, a chiropractor will turn, crack, and/or otherwise apply pressure to various areas of the back of a patient. By applying pressure to the back, the chiropractor can provide relief to injuries and/or pain experienced by the patient.

However, the patient seeking treatment from the chiropractor may not be able to leave the house and/or afford frequent visits. Thus, often times the patient will have to suffer through the pain in the back.

Therefore, there is a need for a back relief device that can apply pressure to the back of a user.

### SUMMARY

The present general inventive concept provides a back relief device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a back relief device, including a mat base to receive at least a portion of a body of a user thereon, a plurality of large pressure ridges disposed on at least a portion of the mat base to at least partially protrude away from the mat base with respect to a direction and positioned based on at least one first pressure point of the user, and a plurality of small pressure ridges disposed between each of the plurality of large pressure ridges on at least a portion of the mat base to at least partially protrude away from the mat base with respect to the direction and positioned based on at least one second pressure point of the user.

Each of the plurality of large pressure ridges may be more rigid than the mat base.

Each of the plurality of large pressure ridges may be elongate and rounded in shape.

Each of the plurality of small pressure ridges may be more rigid than each of the plurality of large pressure ridges.

The back relief device may further include a movable ridge detachably connected to at least a portion of the mat base to at least partially protrude away from the mat base with respect to the direction while disposed on the mat base.

The movable ridge may be greater in size than each of the plurality of large pressure ridges and has a different shape than each of the plurality of large pressure ridges.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top perspective view of a back relief device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Back Relief Device 100
Mat Base 110
Large Pressure Ridges 120
Small Pressure Ridges 130
Movable Ridge 140

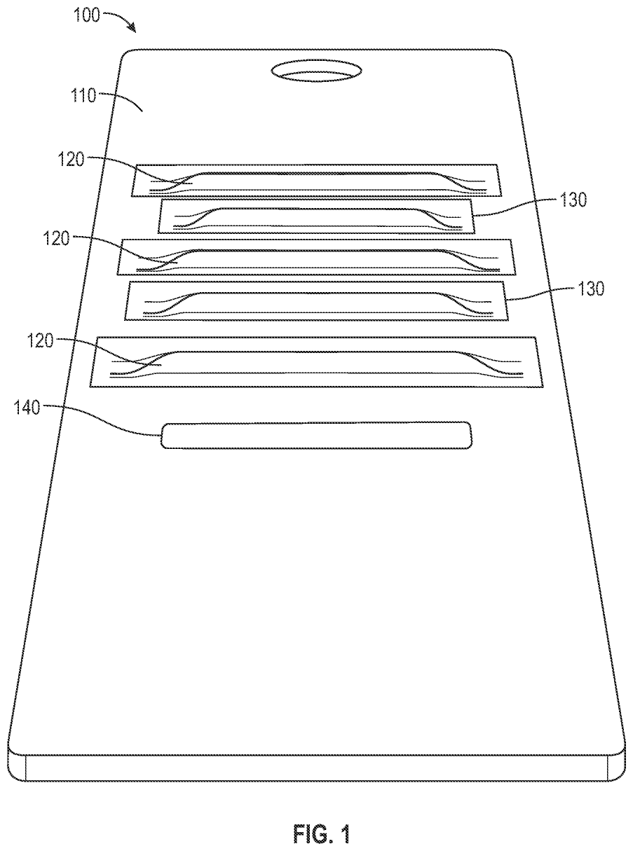

FIG. 1 illustrates a top perspective view of a back relief device 100, according to an exemplary embodiment of the present general inventive concept.

The back relief device 100 may be constructed from at least one of cloth, foam, silicone, metal, plastic, wood, and rubber, etc., but is not limited thereto.

The back relief device 100 may include a mat base 110, a plurality of large pressure ridges 120, plurality of small pressure ridges 130, and a movable ridge 140, but is not limited thereto.

Referring to FIG. 1, the mat base 110 is illustrated to have a rectangular prism shape. However, the mat base 110 may be rectangular, circular, triangular, pentagonal, hexagonal, heptagonal, octagonal, or any other shape known to one of ordinary skill in the art, but is not limited thereto.

The mat base 110 may be a planar surface. The mat base 110 may be a firm and/or a rigid surface. Specifically, the mat base 110 may be inflexible and/or unable to bend. Furthermore, the mat base 110 may be a ribbed surface (i.e., a plurality of ribs) to increase relaxation for a user.

Alternatively, the mat base 110 may be elastic. In other words, the mat base 110 may at least partially deform (i.e., bend, stretch, expand) in response to an application of force (e.g., pushing, pulling) thereto. Thus, the mat base 110 may be rigid and/or elastic depending on construction thereof. Also, the mat base 110 may be rigid on a first portion (e.g., a first half) and/or elastic on a second portion (e.g., a second half). Accordingly, the mat base 110 may be rolled up (e.g., coiled) for storage.

The mat base 110 may receive at least a portion of a body of the user thereon, such as a back, a spine, a torso, a head, a neck, a pelvis, at least one arm, and/or at least one leg thereon. Moreover, the mat base 110 may facilitate relaxation by the user while the user is disposed (e.g., laying down) thereon.

Each of the plurality of large pressure ridges 120 may be constructed to be firmer and/or more rigid with respect to the mat base 110. In other words, the plurality of large pressure ridges 120 may be a harder material than the mat base 110. As such, the plurality of large pressure ridges 120 may stay a same shape regardless of pressure applied thereto.

The plurality of large pressure ridges 120 may be disposed on at least a portion of the mat base 110. Additionally, each of the plurality of large pressure ridges 120 may at least partially protrude (i.e., angularly, perpendicularly) away from the mat base 110 with respect to a direction. Also, each of the plurality of large pressure ridges 120 may be elongate, semi-cylindrical, and/or rounded in shape. The rounded shape of the plurality of large pressure ridges 120 may prevent discomfort and/or injury to the user during use due to being rounded and/or without sharp edges. Accordingly, the plurality of large pressure ridges 120 may apply a firm pressure against the body of the user in response to receiving a portion of the body of the user thereon.

Furthermore, each of the plurality of large pressure ridges 120 may be positioned based on at least one first pressure point on the back of the user. As such, the mat base 110 and/or the plurality of large pressure ridges 120 may be customized to benefit the user. Thus, the plurality of large pressure ridges 120 may apply pressure against a portion of the body (e.g., the back, the spine) of the user in response to an application of force (e.g., pushing, pulling) by the user. The plurality of large pressure ridges 120 may target the at least one first pressure point of the user to facilitate relaxation and/or treatment, such that the plurality of large pressure ridges 120 may simulate treatment by a chiropractor.

Each of the plurality of small pressure ridges 130 may be constructed to be firmer and/or more rigid with respect to the plurality of large pressure ridges 120. In other words, each of the plurality of small pressure ridges 130 may be a harder material than at least one of the plurality of large pressure ridges 120. As such, the plurality of small pressure ridges 130 may stay a same shape regardless of pressure applied thereto.

The plurality of small pressure ridges 130 may be disposed on at least a portion of the mat base 110. Specifically, each of the plurality of small pressure ridges 130 may be disposed between two of the plurality of large pressure ridges 120. Additionally, each of the plurality of small pressure ridges 130 may at least partially protrude (i.e., angularly, perpendicularly) away from the mat base 110 with respect to a direction (e.g., same direction as the plurality of large pressure ridges 130). Also, each of the plurality of small pressure ridges 130 may be elongate, semi-cylindrical, and/or rounded in shape. The rounded shape of the plurality of small pressure ridges 130 may prevent discomfort and/or injury to the user during use due to being rounded and/or without sharp edges. Accordingly, the plurality of small pressure ridges 130 may apply a firm pressure against the body of the user in response to receiving a portion of the body of the user thereon.

Furthermore, each of the plurality of small pressure ridges 130 may be positioned based on at least one second pressure point on the back of the user different with respect to the at least one first pressure point applied by each of the plurality of large pressure ridges 120. As such, the mat base 110 and/or the plurality of small pressure ridges 130 may be customized to benefit the user. Thus, the plurality of small pressure ridges 130 may apply pressure against a portion of the body (e.g., the back, the spine) of the user in response to an application of force (e.g., pushing, pulling) by the user. The plurality of small pressure ridges 130 may target the at least one second pressure point of the user to facilitate relaxation and/or treatment, such that the plurality of small pressure ridges 130 may simulate treatment by a chiropractor.

Referring again to FIG. 1, it is important to note that a number of the plurality of large pressure ridges 120 is illustrated to be greater than a number of the plurality of small pressure ridges 130. However, the number of the plurality of small pressure ridges 130 may be equivalent to and/or greater than the number of the plurality of large pressure ridges 120. Also, a size (e.g., a length, a width, a height) of the plurality of large pressure ridges 120 may be greater than a size (e.g., a length, a width, a height) of the plurality of small pressure ridges 130.

The movable ridge 140 may be detachably connected (e.g., a hook-and-loop fastener, an adhesive (e.g., tape, glue), a pin) to at least a portion of the mat base 110. The movable ridge 140 may be connected to the mat base 110 at any surface of the mat base 110 based on a preference of the user. The movable ridge 140 may at least partially protrude away from the mat base 110 with respect to the direction while disposed on the mat base 110. Accordingly, the movable ridge 140 may apply pressure against a portion of the body of the user in response to an application of force (e.g., pushing, pulling) by the user. The movable ridge 140 may have a size (e.g., a length, a width, a height) greater than the size of each of the plurality of large pressure ridges 120 and/or the size of each of the plurality of small pressure ridges 130.

Also, the movable ridge 140 may have a shape different from a shape of each of the plurality of pressure ridges 120 and/or a shape of each of the plurality of small pressure ridges 130. The movable ridge 140 may target an increased surface area of the body of the user during use in combination with the plurality of large pressure ridges 120 and/or the plurality of small pressure ridges 130, such that the movable ridge 140 may connect to an additional number of pressure points in addition to a number of pressure points targeted by the plurality of pressure ridges 120 and/or the plurality of small pressure ridges 130 in absence of the movable ridge 140.

Therefore, the back relief device 100 may provide pressure to the body of the user to target pressure points for treatment of the body. Also, the back relief device 100 may provide relief to the back and/or the spine without having to visit the chiropractor, such that the user saves time and/or money.

The present general inventive concept may include a back relief device 100, including a mat base 110 to receive at least a portion of a body of a user thereon, a plurality of large pressure ridges 120 disposed on at least a portion of the mat base 110 to at least partially protrude away from the mat base 110 with respect to a direction and positioned based on at least one first pressure point of the user, and a plurality of small pressure ridges 130 disposed between each of the plurality of large pressure ridges 120 on at least a portion of the mat base 110 to at least partially protrude away from the mat base 110 with respect to the direction and positioned based on at least one second pressure point of the user.

Each of the plurality of large pressure ridges 120 may be more rigid than the mat base 110.

Each of the plurality of large pressure ridges 120 may be elongate and rounded in shape.

Each of the plurality of small pressure ridges 130 may be more rigid than each of the plurality of large pressure ridges 120.

The back relief device 100 may further include a movable ridge 140 detachably connected to at least a portion of the mat base 110 to at least partially protrude away from the mat base 110 with respect to the direction while disposed on the mat base 110.

The movable ridge 140 may be greater in size than each of the plurality of large pressure ridges 120 and has a different shape than each of the plurality of large pressure ridges 120.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A back relief device, comprising:
a mat base to receive at least a portion of a body of a user thereon;
a plurality of large pressure ridges disposed on at least a portion of the mat base to at least partially protrude away from the mat base with respect to a direction and positioned based on at least one first pressure point of the user; and
a plurality of small pressure ridges disposed between each of the plurality of large pressure ridges on at least a portion of the mat base to at least partially protrude away from the mat base with respect to the direction and positioned based on at least one second pressure point of the user.

2. The back relief device of claim 1, wherein each of the plurality of large pressure ridges are more rigid than the mat base.

3. The back relief device of claim 1, wherein each of the plurality of large pressure ridges are elongate and rounded in shape.

4. The back relief device of claim 1, wherein each of the plurality of small pressure ridges are more rigid than each of the plurality of large pressure ridges.

5. The back relief device of claim 1, further comprising:
a movable ridge detachably connected to at least a portion of the mat base to at least partially protrude away from the mat base with respect to the direction while disposed on the mat base.

6. The back relief device of claim 5, wherein the movable ridge is greater in size than each of the plurality of large pressure ridges and has a different shape than each of the plurality of large pressure ridges.
